(19) United States
(12) Patent Application Publication
(10) Pub. No.: US 2012/0253728 A1
(43) Pub. Date: Oct. 4, 2012

(54) METHOD AND SYSTEM FOR INTELLIGENT AUTOMATED TESTING IN A MULTI-VENDOR, MULTI-PROTOCOL HETEROGENEOUS ENVIRONMENT

(75) Inventors: Haidar A. CHAMAS, White Plains, NY (US); Fred R. GALLOWAY, Pearl River, NY (US); Robert ORMSBY, Montebello, NY (US); James G. RHEEL, Amityville, NY (US); Charles D. ROBERTSON, Princeton, TX (US)

(73) Assignee: Verizon Patent and Licensing Inc., Basking Ridge, NJ (US)

(21) Appl. No.: 13/078,029

(22) Filed: Apr. 1, 2011

(51) Int. Cl. G06F 19/00

(52) U.S. Cl. 702/109

(57) ABSTRACT

A method and system for test automation is described. The method may include creating a test case on a client computer; generating expected testing results by manually executing the test case on a computer system; performing automated testing on the computer system using the test case to generate automated testing results; validating the test case by comparing the automated testing results with the expected testing results; marking the test case as automatable, if the automated testing results match the expected testing results; and storing the automatable test case for later execution.

### BACKGROUND INFORMATION

Testing and validation of a product or a service across multi-domain, multi-vendor, multi-protocol heterogeneous networks is quite complex and is currently performed manually on an element-by-element basis. The results are often not consistent, because the configuration, parameters and/or components involved in the testing differ due to user selections or system shortcuts. In addition, testing may be conducted in different phases. Moreover, components, system levels, integration into, e.g., pre-service provider environments and service provider environments may require additional verification and testing. Testing, verification, and validation of these systems require lots of resources and a significant amount of time.

System directed to so-called “next generation” (NG) of services, such as time-division multiplexing (TDM), synchronous optical networking (SONET), dense wavelength division multiplexing (DWDM), Ethernet, IP networking, video and wireless networks with applications such as video on demand (VOD), etc., are dynamic in nature. They may be multi-vendor, multi-domain, multi-protocol systems running across a heterogeneous network environment. These systems require fast and quick turn-around in validation and regression testing of their existing services and their associated service level agreements (SLAs).

Additions of the NG services should not introduce unwanted changes into existing communications. Therefore, regression testing and validation of system performance may be provided to maintain consistency of system operations in integrating the NG services and new features. Automated testing and validation may improve quality and efficiency of test cycles and the underlying products, thereby reducing test cycles and test resources, and enhancing service consistency. Thus, there is a need for a dynamic automated testing and validation system that controls various components in a service provider's networking environment.

### BRIEF DESCRIPTION OF THE DRAWINGS

FIG. 1 is a schematic diagram of an exemplary system environment for implementing exemplary embodiments;

FIG. 2 is a block diagram of an exemplary automation client depicted in FIG. 1;

FIG. 3 is a block diagram of an exemplary automation server depicted in FIG. 1;

FIG. 4 is a block diagram of an exemplary automated testing system;

FIG. 5 is a block diagram of another exemplary automated testing system;

FIG. 6 is a list of exemplary protocols implemented in the system depicted in FIGS. 1-5;

FIG. 7 is an exemplary graphic user interface image generated by the testing method;

FIGS. 8A and 8B are exemplary flow diagrams of an automated testing process, consistent with an exemplary embodiment;

FIG. 9 is an exemplary flow diagram of a suite automation learning process;

FIG. 10 is an exemplary flow diagram of a test case sequencing process;

FIG. 11 is an exemplary flow diagram of a multi-vendor testing process;

FIG. 12 is an exemplary flow diagram of a network system scaling process;

FIG. 13 is an exemplary flow diagram of an automated testing process, consistent with another exemplary embodiment;

FIG. 14 is an exemplary flow diagram of an adjustment-bypass routine;

FIG. 15 is an exemplary flow diagram of an automation process for automating a test case;

FIG. 16 is an exemplary flow diagram of a learning process;

FIG. 17 is an exemplary flow diagram of a sequence indexing process; and

FIG. 18 is an exemplary flow diagram of a process for creating a network circuit for automation testing.

### DETAILED DESCRIPTION

Reference will now be made in detail to exemplary embodiments, examples of which are illustrated in the accompanying drawings. The following description refers to the accompanying drawings in which the same numbers in different drawings represent similar elements, unless otherwise stated. The implementations set forth in the following description of exemplary embodiments consistent with the present invention do not represent all implementations. Instead, they are merely examples of systems and methods consistent with the invention, as recited in the appended claims.

Various exemplary embodiments described herein provide methods and systems for performing automated testing in a telecommunication system. A method includes creating a test case on a client computer; generating expected testing results by manually executing the test case on a computer system through the client computer; performing automated testing on the computer system using the test case to generate automated testing results; validating, by an automation server, the test case by comparing the automated testing results with the expected testing results; marking the test case as automatable if the automated testing results match the expected testing results; and storing, by the automation server, the automatable testing case for later executions.

In a further embodiment, generating the expected testing results further includes manually operating the program through a plurality of testing steps; and storing the expected testing results corresponding to each testing step. The expected testing results may include screen shot images collected at the testing steps. Validating the test case includes comparing the expected testing results and the automated testing results for each step.

In another embodiment, the method further includes (a) adjusting a parameter of the test case if validation of the test case fails; (b) re-executing the test case with the adjusted parameter to generate adjusted automated testing results; and (c) re-validating the test case by comparing the expected testing results with the adjusted automated testing results. Steps (a)-(c) may be performed for a predetermined number of times.

In still another embodiment, the method further includes obtaining a plurality of automatable test cases; determining sequencing times for the automatable test cases; grouping the automatable test cases into a test suite; and ordering the automatable test cases into a time-indexed sequence based on the times.

In still another embodiment, the computer system is disposed in one of an element management system or a network management system of a telecommunication network. The computer system is configured to manage a plurality of network elements of the telecommunication network. The network elements may form at least one of an optical network, a packet network, a switched network, or an IP network. The telecommunication network may be configured based on telecommunication management network (TMN) architecture, such as those defined in the Telcordia Generic Requirements (available at http://telecom-info.telcordia.com/site-cgi/ido/docs2.pl?ID=052977169&page=docs_doc_center) or the TeleManagement Forum (TMF) framework (available at http://www.tmforum.org/TechnicalReports/865/home.html).

According to still another embodiment, a system is provided for performing automated testing in a heterogeneous network environment. The system includes one or more thin clients and an automation server, which are connected to a heterogeneous network environment through network interfaces. According to another embodiment, a method is provided for automatically discovering and testing network elements and circuit levels in the heterogeneous network. The method allows a user to create, move, add, change, and delete physical and logical network topologies and associated services over network foundation for TCP/IP and OSI layers, such as TDM, SONET, packet networks, video networks, radio-based wireless networks, and packet-based wireless networks.

The system programming components may be independently selected and executed dynamically to test or validate all of the underlying software, hardware, network topologies, and services in an automated fashion without user intervention. The selection of a component may be randomly made. The system programming intelligence may identify all of the required dependencies and execute the automatable test cases according to a time sequence and in a synchronized manner. Also the system may validate steps to ensure accurate and consistent outcomes. The system may store network topology data and maps, all associated parameters, and configuration files locally or in a virtual network environment.

The system may further determines changes in a new software or hardware release that potentially impacts clients or the service provider, and may help identify the level of severity caused by the changes. The automation system may follow a systematic approach in achieving its consistent accurate outcome.

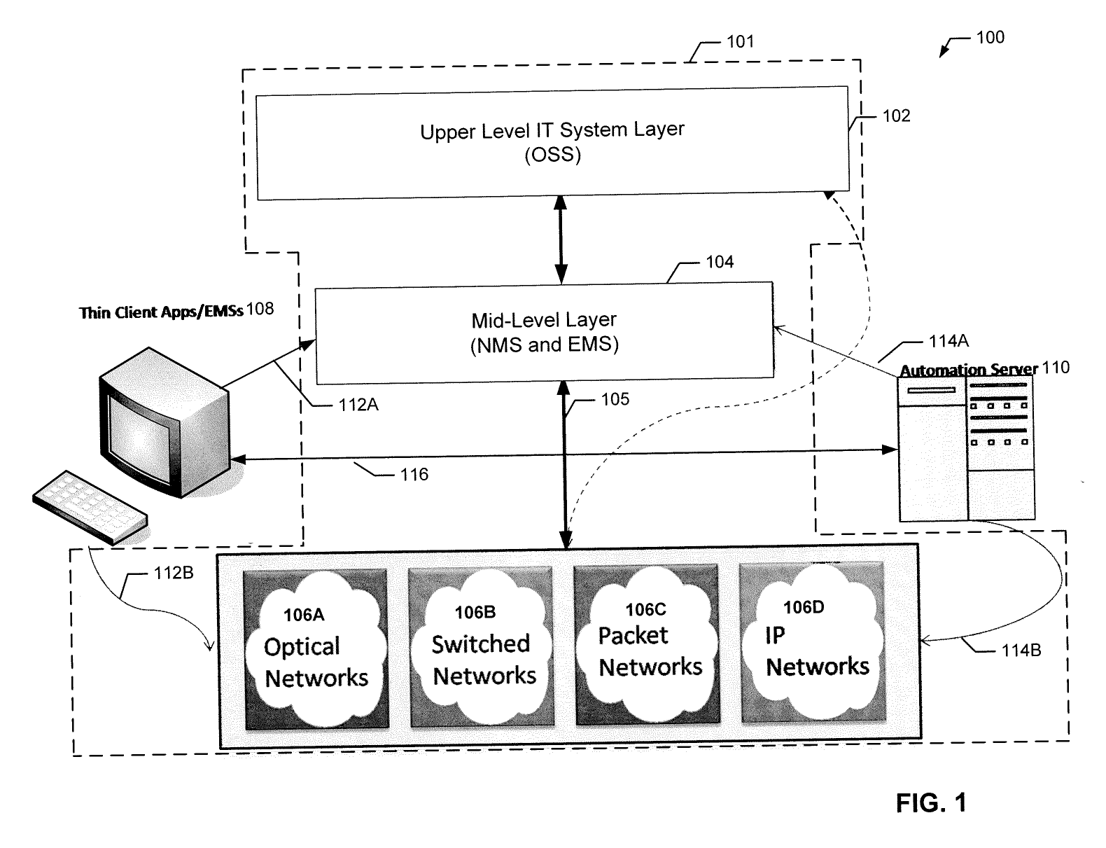

FIG. 1 depicts a schematic diagram of an automated testing system in accordance with various embodiments described herein. FIG. 1 shows an exemplary heterogeneous network environment 100, within which an automated testing system operates. The automated testing system including at least one automation server 110 and one or more automation clients 108.

In general, clients 108 may be implemented on a variety of computers such as desktops, laptops, or handheld devices. Clients 108 may be implemented in the form of thin clients, which require minimum computational power. Server 110 may be implemented on one or more general purpose server computers or proprietary computers that have adequate computational power to provide network testing functionalities as described herein. Clients 108 and server 110 communicate with each other through various network protocols, such as the hypertext transfer protocol (“HTTP”), the user datagram protocol (“UDP”), the file transfer protocol (“FTP”), and the extensible markup language (“XML”).

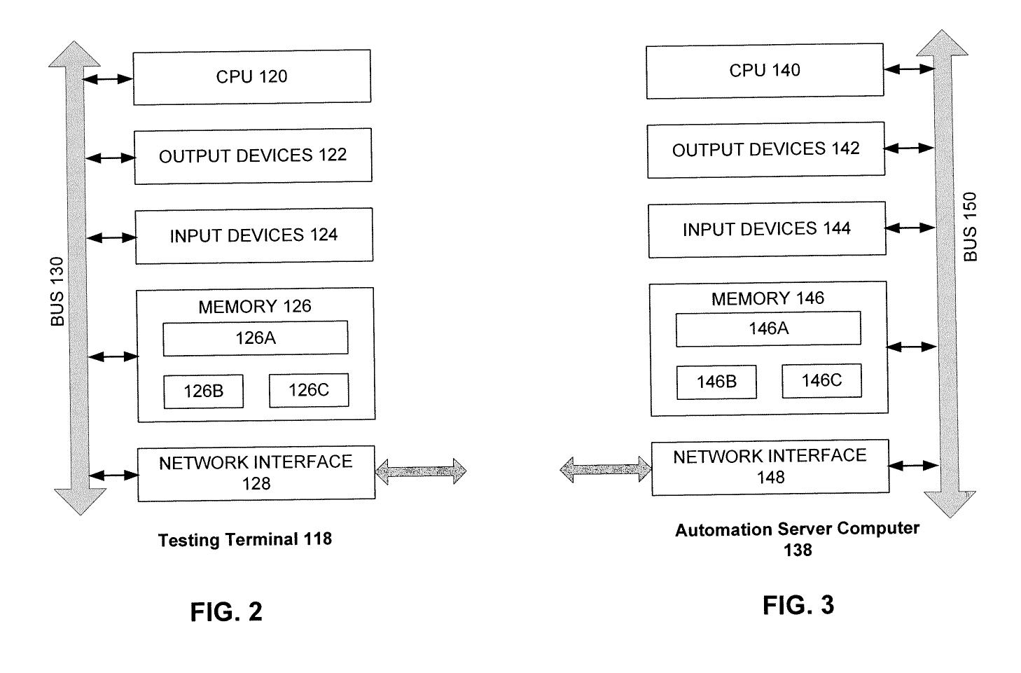

FIG. 2 is a block diagram exemplifying one embodiment of a testing terminal 118 for implementing clients 108. Testing terminal 118 illustrated in FIG. 2 may include a central processing unit (CPU) 120; output devices 122; input devices 124; memory unit 126; network interface 128. The system components are connected through one or more system buses 130. CPU 120 may include one or more processing devices that execute computer instructions and store data in one or more memory devices such as memory unit 126.

Input devices 124 may include input interfaces or circuits for providing connections with a system bus 130 and communications with other system components such as CPU 120 and memory 126. Input devices may include, for example, a keyboard, a microphone, a mouse, or a touch pad. Other types of input devices may also be implemented consistent with the disclosed embodiments. Output devices 122 may include, for example, a monitor, a printer, a speaker, or an LCD screen integrated with the terminal. Similarly, output devices 122 may include interface circuits for providing connections with system bus 130 and communications with other system components. Other types of output devices may also be implemented consistent with the disclosed embodiments.

Network interface 128 may include, for example, a wired modem, a wireless modem, an Ethernet adaptor, a Wi-Fi interface, or any other network adaptor as known in the art. In general, the network interface 128 provides network connections and allows testing terminal 118 to exchange information with automation server 110 and service provider system 101.

CPU 120 may be any controller such as an off-the-shelf microprocessor (e.g., INTEL PENTIUM), an application-specific integrated circuit (“ASIC”) specifically adapted for testing terminal 118, or other type of processors. Memory unit 126 may be one or more tangibly embodied computer-readable storage media that store data and computer instructions, such as operating system 126A, application program 126B, and application data 126C. When executed by CPU 120, the instructions cause terminal 118 to perform the testing methods described herein. Memory unit 126 may be embodied with a variety of components or subsystems, including a random access memory (RAM), a read-only memory (ROM), a hard drive, or a flash drive.

FIG. 3 is a block diagram exemplifying one embodiment of server computer 138 for implementing automation server 110. Automation server computer 138 illustrated in FIG. 3 may include a central processing unit (CPU) 140; output devices 142; input devices 144; memory unit 146; and network interface 148. The system components are connected through one or more system buses 150. CPU 140 may include one or more processing devices that execute computer instructions and store data in one or more memory devices such as memory unit 146.

Input devices 144 may include input interfaces or circuits for providing connections with system bus 150 and communications with other system components such as CPU 140 and memory unit 146. Input devices 144 may include, for example, a keyboard, a microphone, or a mouse. Other types of input devices may also be implemented consistent with the disclosed embodiments. Output devices 142 may include, for example, a monitor, a printer, or a speaker. Similarly, output devices 142 may include interface circuits for providing connections with system bus 150 and communications with other system components. Other types of output devices may also be implemented consistent with the disclosed embodiments.

Network interface 148 may include, for example, a wired modem, a wireless modem, an Ethernet adaptor, a Wi-Fi interface, or any other network adaptor as known in the art. In general, network interface 148 provides network connections with testing clients 108 and/or service provider system 101 and allows automation server computer 138 to exchange information with clients 108 and service provider system 101.

CPU 140 may be any controller such as an off-the-shelf microprocessor (e.g., INTEL PENTIUM). Memory unit 146 may be one or more memory devices that store data and computer instructions, such as operating system 146A, server application programs 146B, and application data 146C. When executed by CPU 140, the instructions cause automation server computer 138 to communicate with clients 108 and perform the testing methods described herein. Memory unit 146 may be embodied with a variety of components or subsystems, including a random access memory (RAM), a read-only memory (ROM), a hard drive, or a flash drive. In particular, application programs 146B may include an automation testing server application to interact with client 108. Application data 146C may include an electronic database for storing information pertinent to the automated testing, such as testing cases, testing suites, testing parameters, etc.

The configurations or relationships of components illustrated in FIGS. 1-3 are exemplary. For example, input and output devices 122, 124, 142, and 144, such as the display, the keyboard, and the mouse, may be a plurality of independent devices within separate housings detachably connected to a generic controller, such as a personal computer or set-top box. In other implementations, CPUs 120 and 140 and the input and output devices may be integrated within a single housing. Different configurations of components may be selected based on the requirements of a particular implementation of the system. In general, factors considered in making the selection include, but are not limited to, cost, size, speed, form factor, capacity, portability, power consumption and reliability.

Referring back to FIG. 1, service provider system 101, which is under test by automation server 110 and testing clients 108, is a distributed telecommunication system which includes a plurality of computers and their associated software programs. In general, service provider system 101 is arranged in a hierarchical architecture with a plurality of functional layers, each supporting a group of functions. According to one embodiment, service provider system 101 includes an upper level IT system layer 102, a mid-level management layer 104, and a lower level physical layer 106. In some embodiments, the system levels may be further configured based on the telecommunication management network (TMN) architecture. The TMN architecture is a reference model for a hierarchical telecommunications management approach. The TMN architecture is defined in the ITU-T M.3010 standard published in 1996, which is hereby incorporated by reference in its entirety.

According to the TMN architecture, service provider system 101 includes various sub-systems within the layers. These sub-systems include an operations support system (OSS) residing in upper level IT system layer 102; a network management system (NMS) and an element management system (EMS) residing in mid-level management layer 104, and network elements residing in physical layer 106.

Service provider system 101 segregates the management responsibilities based on these layers. Within the TMN architecture, it is possible to distribute the functions or applications over the multiple disciplines of a service provider and use different operating systems, different databases, different programming languages, and different protocols. System 101 also allows each layer to interface with adjacent layers through appropriate interfaces to provide communications between applications, thereby allowing more standard computing technologies to be used. As a result, system 101 allows for use of multiple protocols and multiple vendor-provided systems within a heterogeneous network.

Specifically, each layer in service provider system 101 handles different tasks, and includes computer systems, equipment, and application programs provided by different vendors. For example, the OSS in upper level 102 may include a business management system and a service management system for maintaining network inventory, provisioning services, configuring network components, and managing faults.

Mid-level layer 104 may include a network management system (NMS) and an element management system (EMS). Mid-level layer 104 may be integrated with upper layer Information Technology (IT) systems via north-bound interfaces (NBIs), with network element (NE) systems via south-bound interfaces (SBIs), or with any associated end-to-end system via west and east bound interfaces (WBIs and EBIs) for a complete end-to-end environment as deployed in a service provider or a customer environment.

The network management system (NMS) in mid-level layer 104 is responsible for sharing device information across management applications, automation of device management tasks, visibility into the health and capability of the network, and identification and localization of network malfunctions. The responsibility of the NMS is to manage the functions related to the interaction between multiple pieces of equipment. For example, functions performed by the NMS include creation of the complete network view, creation of dedicated paths through the network to support the QoS demands of end users, monitoring of link utilization, optimizing network performance, and detection of faults.

The element management system (EMS) in mid-level layer 104 is responsible for implementing carrier class management solutions. The responsibility of the EMS is to manage network element functions implemented within single pieces of equipment (i.e., network element). It is capable of scaling as the network grows, maintaining high performance levels as the number of network events increases, and providing simplified integration with third-party systems. For example, the EMS provides capabilities for a user to manage buffer spaces within routers and the temperatures of switches.

In a further embodiment, the EMS may communicate with the network elements in physical layer 106 through an interface 105. Interfaces 105 may use various protocols, such as the Common Management Information Protocol (CMIP), the Transaction Language 1 protocol (TL1), the Simple Network Management Protocol (SNMP), or other proprietary protocols. Generally, the EMS communicates with the network elements using protocols native to the network elements. The EMS may also communicate with other upper-level management systems, such as the network management system, the business management system, and the service management system, through an interface 103 using protocols that are cost-effective to implement.

Physical layer 106 includes network elements such as switches, circuits, and equipment provided by various vendors. Network elements operating based on different network protocols may co-exist within this layer, thereby forming multiple types of networks, such as optical networks 106A, switched networks 1068, packet networks 106C, and IP networks 106D. One skilled in the art will appreciate that any of these networks may be wired or wireless and other types of networks known in the art may also be included in physical layer 106.

As discussed above, the network management system (NMS) and the element management system (EMS) in mid-level layer 104 include a plurality of vender-provided sub-systems. In general, each vendor-provided sub-system is responsible for managing a subset of network elements and network element data associated with these network elements, such as logs, activities, etc. These EMS sub-systems may include computer hardware and programs for communicating, processing, and storing managing information in the managed network elements, such as information on fault, configuration, accounting, performance, and security (FCAPS).

In general, when a vendor provides a new NMS or EMS sub-system or updates an existing sub-system, testing must be conducted to ensure the new or updated system is free of bugs and errors and compatible with existing system infrastructures in system 101. Specifically, the vendor-provided system is tested against the requirements specified by the service provider of system 101. Such testing of the NMS and EMS equipment and devices involves a great deal of challenges. For example, negative conditions and critical test scenarios such as device failures and agent crashes occur very infrequently and are difficult to recreate. In addition, manual testing requires trained personnel with substantial technical expertise and knowledge on specific technologies they support.

As shown in FIG. 1, automation server 110 and testing clients 108 allow testing personnel to create testing scenarios, testing cases, testing suites, and other testing parameters, and automatically test the NMS and EMS equipment and sub-systems provided by a third-party vendor and a home-grown development team. In general, server 110 and clients 108 communicate with each other and with system 101 through various connections for carrying out the automated testing.

Specifically, clients 108 are connected to the EMS in mid-level layer 104 through an interface 112A. Interface 112A may include a computer port, a router, a switch, a computer network, or other means through which clients 108 and the mid-level equipment may exchange data. These data include testing commands, testing parameters, and testing results, etc.

In a further embodiment, clients 108 and server 110 may communicate with each other through an interface 116. According to this embodiment, interface 116 may include a client-server application connection, a computer port, a router, a switch, or computer networks as well known in the art. According to another embodiment, clients 108 and server 110 may communicate with each other through mid-level layer 104. In this embodiment, server 110 may be connected to the EMS equipment in mid-level layer 104 through an interface 114A, which is substantially similar to interface 112A. In still another embodiment, clients 108 and server 110 may communicate with each other through the physical layer networks, such as optical networks 106A, switch networks 106B, packet networks 106C, and IP networks 106D. Other networks, such as wireless networks, cloud networks, video networks, can also be incorporated in to physical layer 106. In this embodiment, clients 108 and server 110 may be connected to any one of networks 106A-D through interfaces 112B and 114B, respectively. Interfaces 112B and 114B may be substantially similar to interfaces 112A.

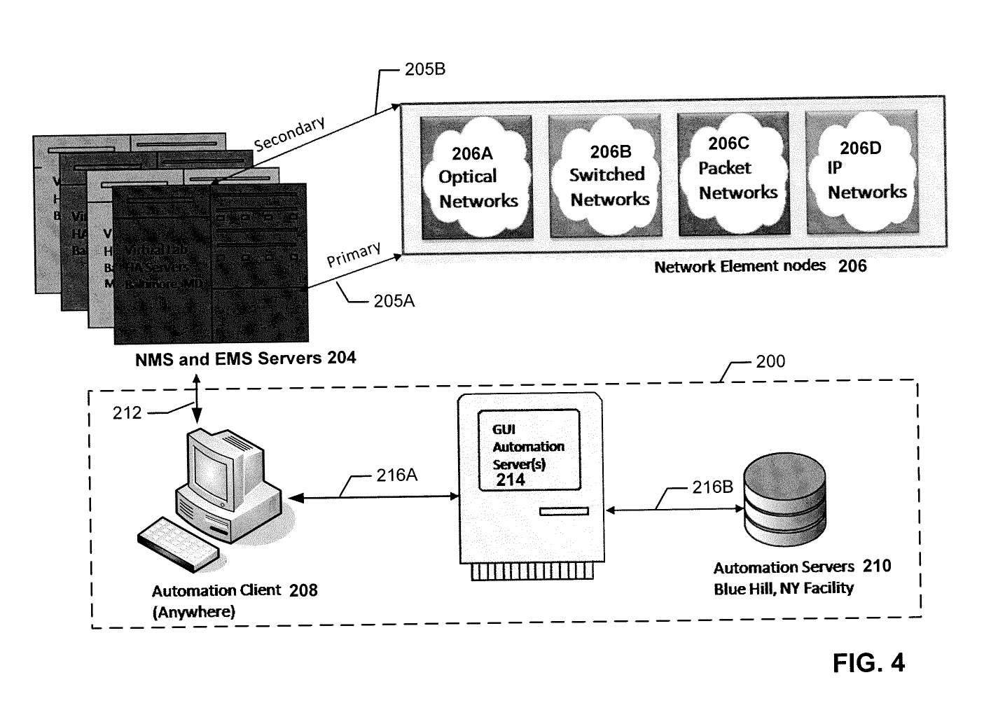

FIG. 4 illustrates another embodiment, an automated testing system 200, for testing new equipment or new functionalities in service provider system 101. As depicted in FIG. 4, automated testing system 200 includes at least one automation client 208, one or more automation servers 210, and a graphic user interface (GUI) automation server 214, which is provided by a GUI automation testing program. In one embodiment, the client software program providing GUI automation server 214 resides on client system 208, which communicates with automation server 210 through an interface 216B. In this embodiment, interface 216B is similar to interface 116 depicted in FIG. 1. GUI automation server 214 communicates with other programs on client 208 through a program interface 216A.

In another embodiment, GUI automation server 214 may reside on automation server 210, which communicates with client 208 through interface 216A. In this embodiment, interface 216A is similar to interface 116 depicted in FIG. 1. GUI automation server 214 communicates with other programs on server 210 through program interface 216B.

In still another embodiment, GUI automation server 214 may reside on a standalone computer system (not shown), which communicates with client 208 and server 210 through interfaces 216A and 216B. In this embodiment, interfaces 216A and 216B may be similar to interface 116 depicted in FIG. 1.

GUI automation server 214 may be provided by a third-party automation program as well known in the art, such as the EGGPLANT by TESTPLANT LTD., the QUICKTEST by HEWLETT-PACKARD, or the PHANTOM AUTOMATION by MICROSOFT. In general, GUI automation server 214 allows a user to create or setup test-related data and programs, such as test cases, test suites, or other test parameters. The user may do so by accessing GUI automation server 214 through automation client 208 or through automation server 210. The test-related data and programs may be stored on the automation server 210 and retrieved for conducting the automated testing when necessary. In addition, testing results generated from the testing may be collected through automation client 208 and stored in GUI automation server 214 or automation server 210.

As further depicted in FIG. 4, automation client 208 communicates with NMS and EMS servers 204, which are under test, through an interface 212. Interface 212 may be substantially similar to interface 112A in FIG. 1. NMS and EMS servers 204 include vendor-provided equipment, third-party equipment, or home-grown equipment, such as computer systems, programs, or applications. These systems should be tested against the requirements specified by the service provider before they are connected to service provider system 101. NMS and EMS servers 204 may include one or more general-purpose or proprietary computer systems, residing in mid-level layer 104 depicted in FIG. 1.

In a further embodiment, each NMS or EMS server 204 may include a primary system and a secondary system. The secondary system provides failover or backup functions. For example, communications are automatically switched over from the primary system to the secondary system upon failures or abnormal terminations of the primary system. Alternatively, the primary and secondary systems may both be functioning at the same time, with the secondary system providing system backup for the primary system. The primary and secondary systems communicate with network element nodes in physical layer through primary interface 205A and secondary interface 205B, respectively.

Similar to networks 106A-D in FIG. 1, networks 206A-206D may take various forms such as the optical networks, the switched networks, the packet networks, and the IP networks, and include a number of network element nodes 206 such as routers, switches, circuits, etc. Each of NMS and EMS servers 204 under test is responsible for managing one or more network elements nodes 206 and the data associated with them.

According to a further embodiment, system 200 may have a distributed network structure in which the components of the system are located in different geographical locations. For example, as shown in FIG. 4, automation server 210 may be installed in Blue Hill, N.Y., NMS, and automation client 208 may be a computer residing anywhere on the network. NMS and EMS servers 204, which are under test, may be in another location such as Baltimore, Md. Furthermore, each of networks 206A-D may cover a geographical area for providing telecommunications to customers. The area may be different from any of the locations of NMS and EMS servers 204, automation server 210, and automation client 208.

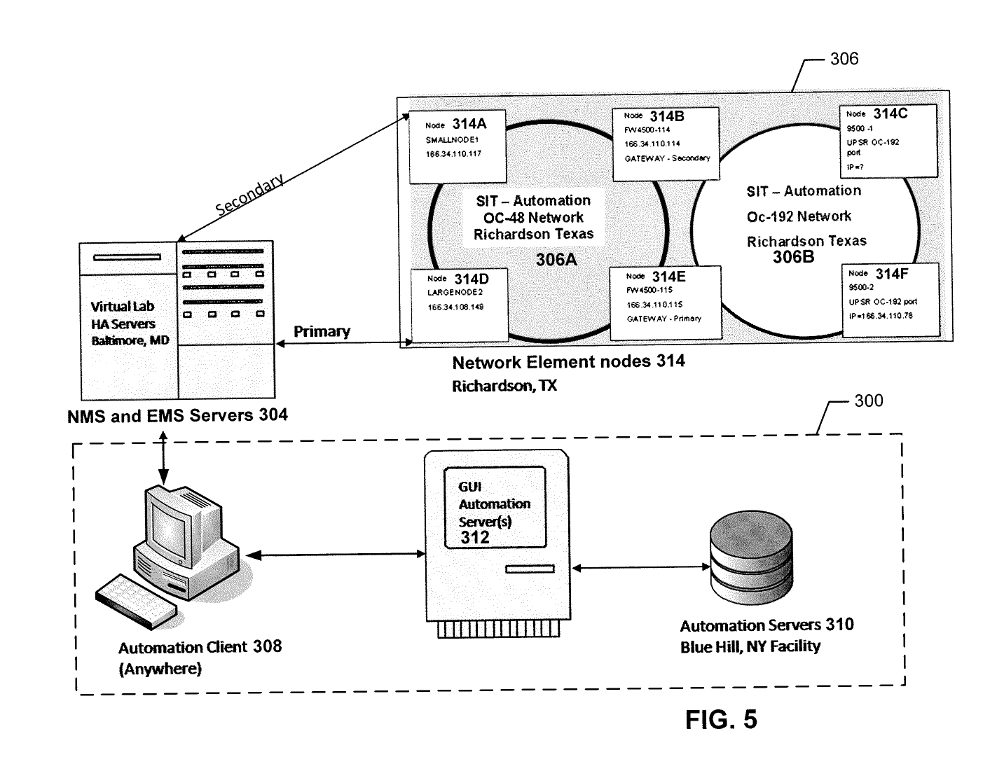

FIG. 5 shows another embodiment, automated testing system 300, where the underlying physical network has a ring structure. Specifically, system 300 may include automation servers 310 located in Blue Hill, N.Y., and at least one automation client 308, which may be anywhere on the network. GUI automation server 312 is a third-party testing program as described above. NMS and EMS servers 304, which are under test, may be in Baltimore, Md. NMS and EMS servers 304 may include computer systems and programs provided by one or more vendors, third parties, or home-grown systems.

Furthermore, NMS and EMS servers 304 manage the service provider's underlying physical network 306, which may include a plurality of network element nodes 314 forming ring networks 306A and 306B. In particular, network nodes 314A, 314B, 314D, and 314E form ring network 306A, and network nodes 314B, 314C, 314E, and 314F form ring network 306B, where network nodes 314B and 314E are common nodes residing in both networks. Network element nodes 314A-F may be provided by the same equipment vendor or different equipment vendors.

In a further embodiment, networks 306A and 306B may or may not cover different geographical areas, such as different parts of Richardson, Tex. Networks 306A and 306B may utilize substantially similar network protocols or different network protocols. In addition, network 306 may be managed by one or more NMS and EMS servers 304 residing in a remote location, such as Baltimore, Md. Similar to servers 204, each NMS and EMS server 304 may include a primary server and a secondary server for providing failover and backup services. As a result, system 300 is a representation of multi-vendor, multi-protocol heterogeneous network.

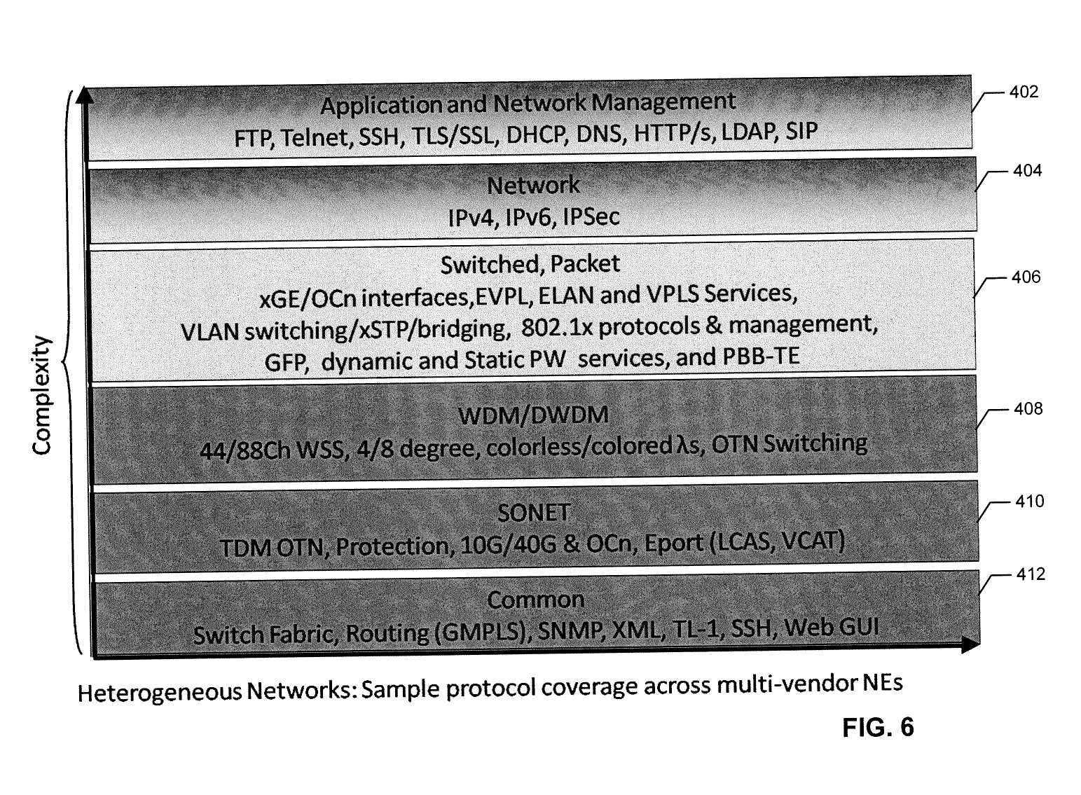

FIG. 6 shows examples of the protocols that can be used in systems 100, 200, and 300. In general, the protocols may belong to different categories, such as application and network management protocols 402, network protocols 404, switched and packet protocols 406, ROADMs, WDM/DWDM protocols 408, SONET protocols 410, and common protocols 412. As FIG. 6 shows, the protocols in upper categories are generally more complex than the protocols in lower categories.

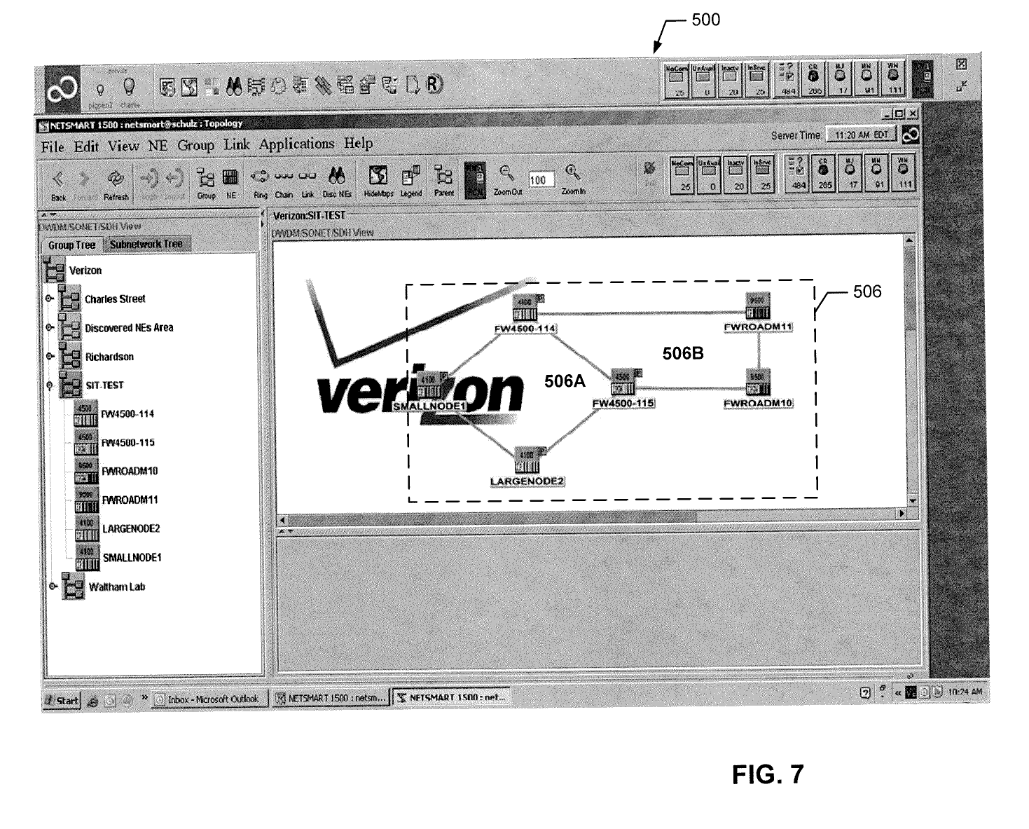

FIG. 7 depicts an exemplary user interface of an EMS program 500 provided by an EMS server for managing physical networks such as networks 106A-D, 206A-D, 306A and 306B. EMS program 500 may be the NETSMART system provided by FUJISU or any other EMS system provided by vendors, third-party entities, or home-grown teams. In general, the NMS or EMS server provides a graphical user interface that allows a service provider to efficiently provision, maintain, and troubleshoot the physical networks. Each NMS or EMS server may accommodate one or more networks of different sizes and support a number of users and network elements. The server can also allow the service provider to provision, detect, or monitor the topology of a physical network. For example, FIG. 7 depicts the topology of a network system 506 set up through EMS program 500. Similar to network 306, network 506 includes two ring networks 506A and 506B. 506A is formed by network nodes FW4500-114, FW4500-115, SMALLNODE1, and LARGENODE2. 506B is formed by network nodes FW4500-114, FW4500-115, FWROADM11, and FWROADM10. EMS program 500 may provide additional functionalities well known in the art.

The automation testing systems depicted in FIGS. 1-7 are capable of determining changes in the new release or updated system equipment, which would potentially impact the service provider and its customer, and identifying the severity of the changes. In particular, the automation testing system may follow a systematic approach in achieving its consistent accurate outcome. The system's construction begins with a blank canvas. The elements and components are added one by one. Then the network topology is added, then the logical topology, and so on.

The automated testing systems depicted in FIGS. 1-7 can be built in stages including the following phases, which may be repeated depending on the design complexity and number of vendors and network elements in the system.

Network Design Discovery, Configuration, and Validation Stage

In this phase, the network components and the configuration of these components are identified. The configuration includes high-level configuration or detailed configuration of the network components. This stage also includes system test bed design, tune-up and validation, network element discovery and learning, and network element validation and verification.

Network Communication Learning, Configuration, and Validation Stage

In this phase, the communication learning process identifies through network discovery the topology types and protocols used in the network. Services are then defined and added to the design. Parameters that need to be determined in this phase include topology types, protocols used in the network, and services supported by the network.

Test Cases Development and Parameter Configuration and Validation Stage

In this phase, the test case development determines the test cases based on given requirements and develops associated use cases as needed. Also, the test case development identifies sequences of these test-case and/or use-case runs that reflect actual field operation practices or process flows. Parameters that need to be established in this stage include per-network test cases and use cases; per-network element and dual-network element protocols used in the network; and per-network element and dual-network element services supported by the network.

Automation and Validation Stage

In this phase, the automation is completed per use case or per suite determined by the developer for sequencing test cases into modules or suites. Specifically, a script is created for each test case and the application under test is tested based on an automation run of the test case via a graphic user interface, which is provided by a testing tool, such as GUI automation server 112. Once each test case is completed, it is tested and validated and the results are compared against expected results obtained during the learning phase or obtained manually by the developer. Once the test cases are verified, they are grouped into a module or suite as a set of test cases/use cases indexed by a relationship order in a time sequence.

This operation is repeated for different test cases and for different network elements. In addition, multiple scripts are also repeated according to the prescribed sequence. The scripts are grouped and placed into appropriate modules. These modules are then validated and verified against expected results. Once finished, these modules are then assembled and ordered into a single script per each field operation/process flow. Each field operation/process flow script is checked against expected results. Once all developments for all process flows are complete, the modules or suites are verified and stored in a centralized server such as automation server 110. Finally, based on the available system resources, the developer applies an appropriate scale to the automation suite.

The steps taken in this stage include test case development; test case validation; test case bypass with configuration and parameters adjustment; test case/user case/suite relationship intelligence; test case/use case/suite timing Index; test case/user case/suite sequence; test case/use case/suite validation; automation phase; and scaling automation.

Scale and Validation Stage

In this phase, the key parameters for scale, such as the number of network elements, links, timing, sequence, are adjusted. The scale of the automation including timing, sequence and, consistency is then validated.

### Automated Testing Process

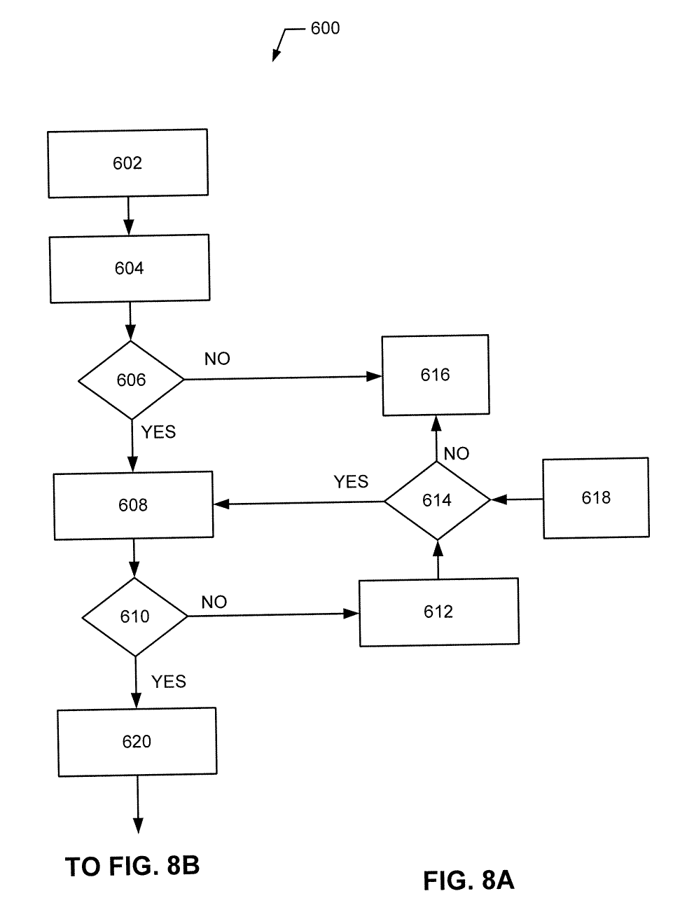

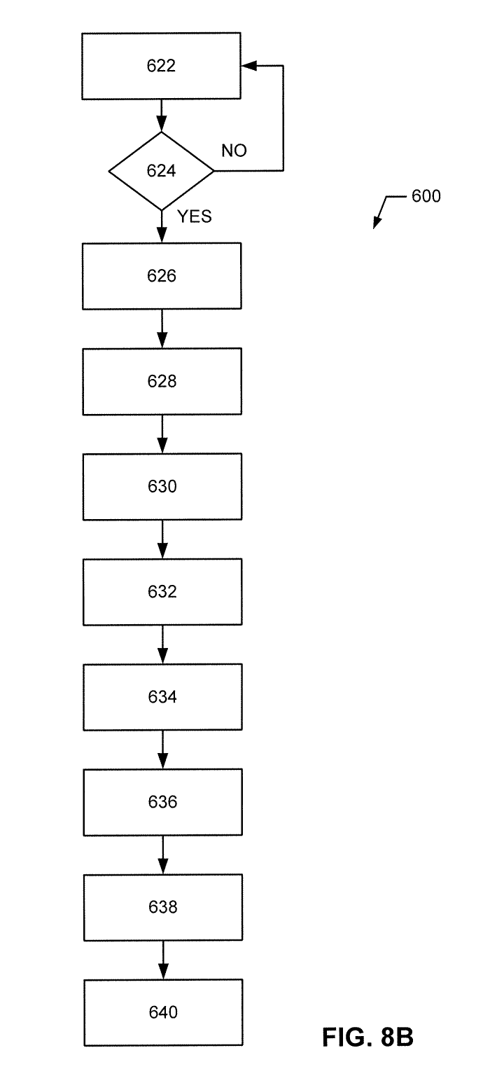

According to another embodiment, an automated testing process is provided for implementation with the automated testing systems depicted in FIGS. 1-7. FIGS. 8A and 8B are flow diagrams of an automated testing process 600 according to various exemplary embodiments. In general, automated testing process 600 includes a number of steps for test automation and regression verification of the NMS and EMS systems, such as the NMS and EMS servers depicted in FIGS. 1, 4, and 5. These process steps may include:

1. Definition Phase;

2. Development Phase;

3. Automation and Validation Phase;

4. System Configuration Phase;

5. Automation Suite Development and Sequencing Algorithm Phase;

6. Equipment Suite Verification and Validation;

7. Network Element Foundation Automation Suite Phase;

8. NE Suite Verification and Validation Phase;

9. Performance Optimization and Metrics Phase;

10. Multi-vendor Network Topology Suite Phase;

11. Heterogeneous Network Automation Suite Phase;

12. Regression Automation Suite Phase;

13. Automation Intelligence Development System Phase; and

14. Reporting and Analysis Phase.

Each of these phases is further described below.

1. Definition Phase

This phase may include step 602 of process 600. The definition phase defines the scope of the key automation objective and the technology areas covered by the testing. In this phase, equipment selections, such as network elements, shelves, cards, modules, etc., are defined. Also, the network map topology and architecture are specified, including physical, logical, and protocol layers. The types of services are outlined with associated performance metrics. In addition, edge-to-edge and end-to-end test sets are defined

2. Development Phase

This phase may include step 604 of process 600. During this phase, the network environment is built and manual test cases are created for test beds in local and/or virtual networks. The test cases are manually executed to ensure their expected results. In general, each manual test run may include from a few to several hundred steps. The manual test cases are documented step-by-step with their corresponding GUI screen shots. An appropriate test management system such as GUI automation server 112 is then utilized to convert each manual test case into an automated test case. This process further includes identifying any alternative mechanism or workaround to reach the required outcome such as shortcuts, GUI Icons, drop-down Menus, pop-up windows, etc.

During manual test case validation and automated test case conversion, specific system parameters may be outlined or defined.

3. Automation and Validation Phase

This phase may include steps 606, 608, 610, 612, 614, and 616, which are focused primarily on building automated test cases and validating them. Specifically, at step 606, it is first determined whether a particular automation test case should be executed. If not, a by-pass process is developed and a skip level is determined (step 616). If the automation test case should be executed, the automation testing is carried out at step 608. At step 608, the automation test results and outcomes are compared to those obtained from the manual test cases.

At step 610, if an automated test case matches the expected results, it is noted as automation ready (step 620). If the automated test case does not match the expected results, then the test case parameters of the automated test case are adjusted at step 612. At step 614, it is determined whether the adjusted automation test case should be re-executed. If yes, the automation test case with the adjusted parameters is re-executed and re-validated against the manual testing results (608).

Should the re-execution and re-validation process continue to fail for a pre-determined number of times, then the test case is labeled as “non-automatable” and a by-pass process is developed at step 616, which is to be used during execution or, if required, during dependency linking in phase 6 as further described below.

For the automatable test cases, they may be stored in automation server 110 at step 620. In addition, they may be further identified and grouped into appropriately-named suites. The test cases in each suite are ordered in a time sequence. The suite includes an index label that is called by a sequencing algorithm, which defines when the suite automation run may be called or executed.

4. Automation System Configuration Phase

This phase may include step 618 and may be independent or in parallel with the Automation and Validation Phase. Specifically, in this phase, a new NMS or EMS system is provided by a vendor, including components such as thin clients, PCs, servers, equipment, network elements, and individual networks.

Alternatively, at step 618, an existing NMS or EMS system may be modified or updated by the vendor to adjust its parameters so as to improve accuracy and performance.

In either case, the system configuration parameters of the NMS or EMS system are input to the Automation and Validation Phase and validated to ensure all of its components are functioning as required.

5. Automation Suite Development and Sequencing Algorithm Phase

This phase includes step 622 as depicted in FIG. 8B, in which the automation suite is developed. Specifically, GUI automation tool 112 is used to sequence the suite events with a time index that is settable or adjustable. The suite is then tested and if passed, a back-out procedure is created to bring the system to its previous state prior to running the next suite. The back-out procedure includes, for example, clearing out all of the parameters, flags, temporary registers, states, memories created during the suite run. The time sequence and index are adjusted to ensure the back-out procedure is efficient.

After both the suite sequence and its back-out procedure are tested and validated, they are packaged into an automation suite with dependency relationship to other suites and run-time sequence. Performance run and suite metrics are recorded and a counter is associated with the suite, which is incremented with each run.

6. Equipment Suite Verification and Validation Phase

This phase includes step 624, in which it is determined whether the automation suite and sequence algorithm have been developed for each vendor component, equipment, and network element. If not, the Automation Suite Development and Sequence Algorithm Phase (step 622) is repeated for each component, equipment, and network element. If yes, the process continues onto the next phase.

7. Network Element Foundation Automation Suite Phase

This phase includes step 626, in which all of the equipment suites are integrated into a network element suite with the proper sequencing and time indices to form the network element foundation suite. This phase is repeated for every network element within a common management framework within the NMS or EMS systems.

8. Network Element Suite Verification and Validation Phase

This phase include step 628. During this phase, each network element suite in the multi-vendor and multi-protocol system is verified and validated.

9. Performance Optimization and Metrics Collection Phase

This phase include step 630. During this phase, performance enhancements may be made to optimize the network element suite and metrics are collected to be used in the reporting and analysis phase.

10. Multi-Vendor Network Topology Suite Phase

This phase includes step 632. During this phase, the topology suite is created, utilizing the network element suites developed earlier.

11. Heterogeneous Network Automation Suite Phase

This phase includes step 634. During this phase, the heterogeneous network automation suite is tested and validated. This phase forms the foundation for the network automation suite.

12. Regression Automation Suite Phase

This phase includes step 636. During this phase, the regression automation suite is built with the hierarchy that connects suites together for all vendor equipment, network elements, and network topologies. More than one network topology across a virtual network and across a virtual lab environment may be tested and validated. A user can run the entire suite by clicking on a selection or hitting a single key.

13. Automation Intelligence Development System Phase

This phase includes step 638. In this phase, the user can select and run any release cycle for regression testing. Program code is written to ensure that any selected component identifies the appropriate dependencies and sequence and, once completed, will clean out all states resulting from the automation run in preparation for the next testing request. Minor adjustments may be required to accommodate for minor release GUI or code changes.

Furthermore, additions of new equipment, new features, and/or new services are possible during this phase if they are not dependent on new software or new equipment. If these new additions are dependent on new software or new equipment, they require a complete automation testing process starting from phase 1 as described above.

14. Reporting and Analysis Phase

This phase includes step 640. It provides the final automation run analysis and reports parameters including, for example, the number of test cases, the number of test steps, the time duration for the testing process, the number of runs due to the by-pass procedure, the number of failed steps, the number of by-pass captured images, etc.

### SIT Intelligent Automation Process

System Integration Testing (SIT) is a testing process for testing a software system's interactions with users, other components, or others systems. System integration testing takes multiple integrated systems that have passed previous system testing as input and tests their required interactions. Following this process, the deliverable systems are passed on to acceptance testing.

In general, SIT is performed after system testing and conducted on a smaller scale or for each individual component and sub-system. During the pre-automation phase of the system integration testing process, the requirements are defined for the project automation, and the manual test cases and the regression test cases are developed. These manual and regression test cases form the building blocks for developing use cases that test end-to-end, edge-to-edge, and network-to-network services. The use cases dependencies include parameters or variables that are set or identified prior to execution (i.e., a-priori) or post execution (i.e., posteriori), or generated during the use case execution. These dependencies ensure run consistency under normal load or stress environment.

### Automation Process Flows

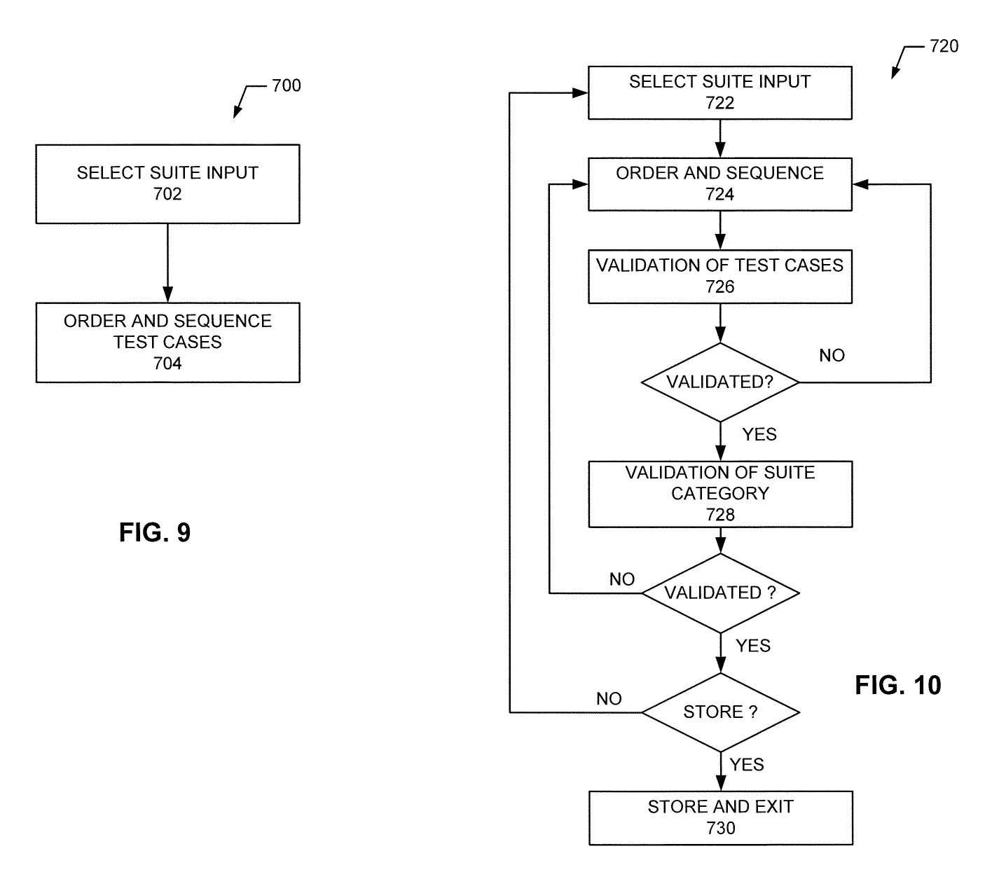

FIGS. 9-12 depict individual processes implemented in process 600. They are described as follows.

Suite Automation Learning Process

FIG. 9 depicts an embodiment of a suite automation learning process 700, including selecting suite input 702 and ordering and sequencing the test cases in the suite input.

Sequencing Process

FIG. 10 depicts an embodiment of a sequencing process 720. In particular, sequencing process 720 includes selecting suite input 722, ordering and sequencing the test cases in the suite input at step 724, and validating the suite at step 726. If the validation fails, process 720 returns to step 724 to re-order the test cases. If the validation succeeds, process 720 continues to validate the suite category at step 728. If the validation of the suite category fails, process 720 returns to step 724 again. If the validation of the suite category succeeds, process 720 determines whether the suite input should be stored. If yes, process 720 continues to store the suite input and exits at step 730. If not, process 720 returns to step 702 to receive another suite input.

Multi-Vendor Testing Process

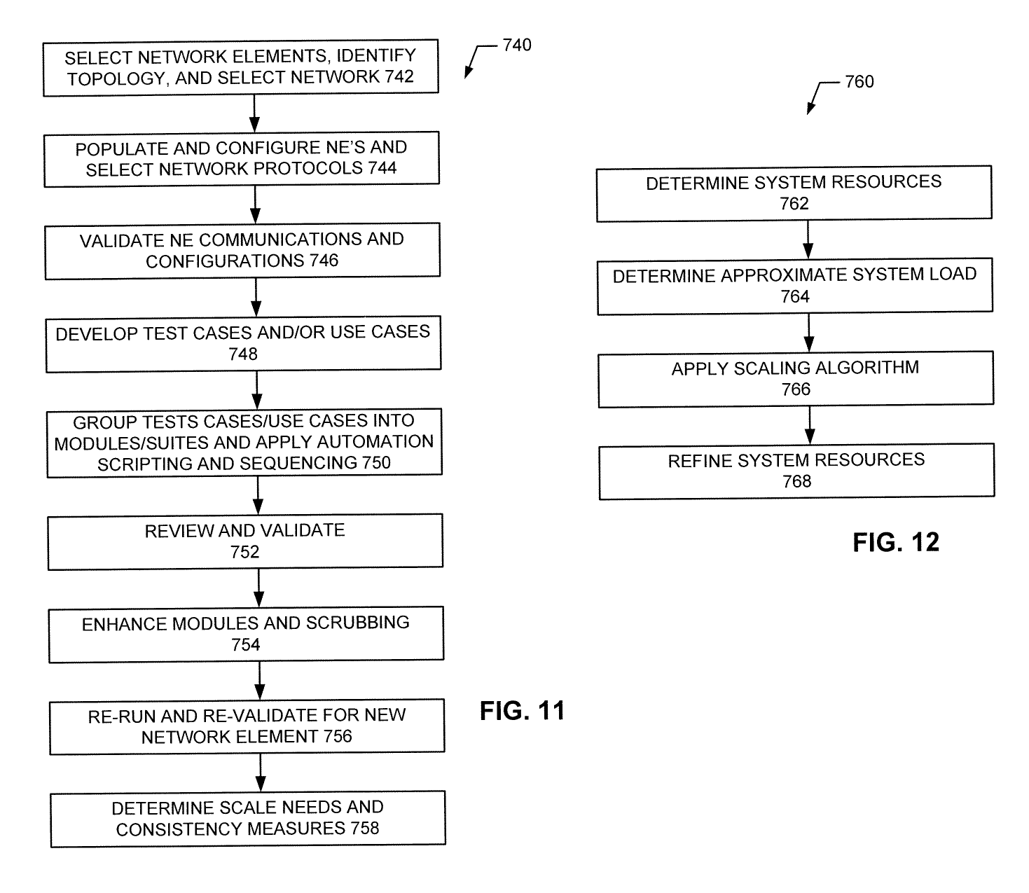

FIG. 11 depicts an embodiment of multi-vendor testing process 740. Specifically, multi-vendor testing process 740 includes selecting network elements, identifying a network topology, and selecting a network at step 742, populating the network elements with cards, configuring the network elements, and selecting protocols for the network elements at step 744, validating the network element communications and configurations at step 746, developing test cases and use cases at step 748, grouping the test cases and use cases into modules and/or suites and applying automation scripting and sequencing at step 750, reviewing and validating the test cases and use cases and storing the test cases and use cases with their testing results at step 752, enhancing the modules and scrubbing, if needed, for similar network elements at step 754, re-running and re-validating new network elements at step 756, and determining scale needs and consistency measures at step 758.

Scaling Process

FIG. 12 depicts an embodiment of a scaling process 760. Specifically, scaling process 760 includes determining system resources at step 762, including cycles, memory, input/output, etc.; determining the approximate system load at step 764; applying the scaling algorithm at step 766; and refining the system resources at step 768.

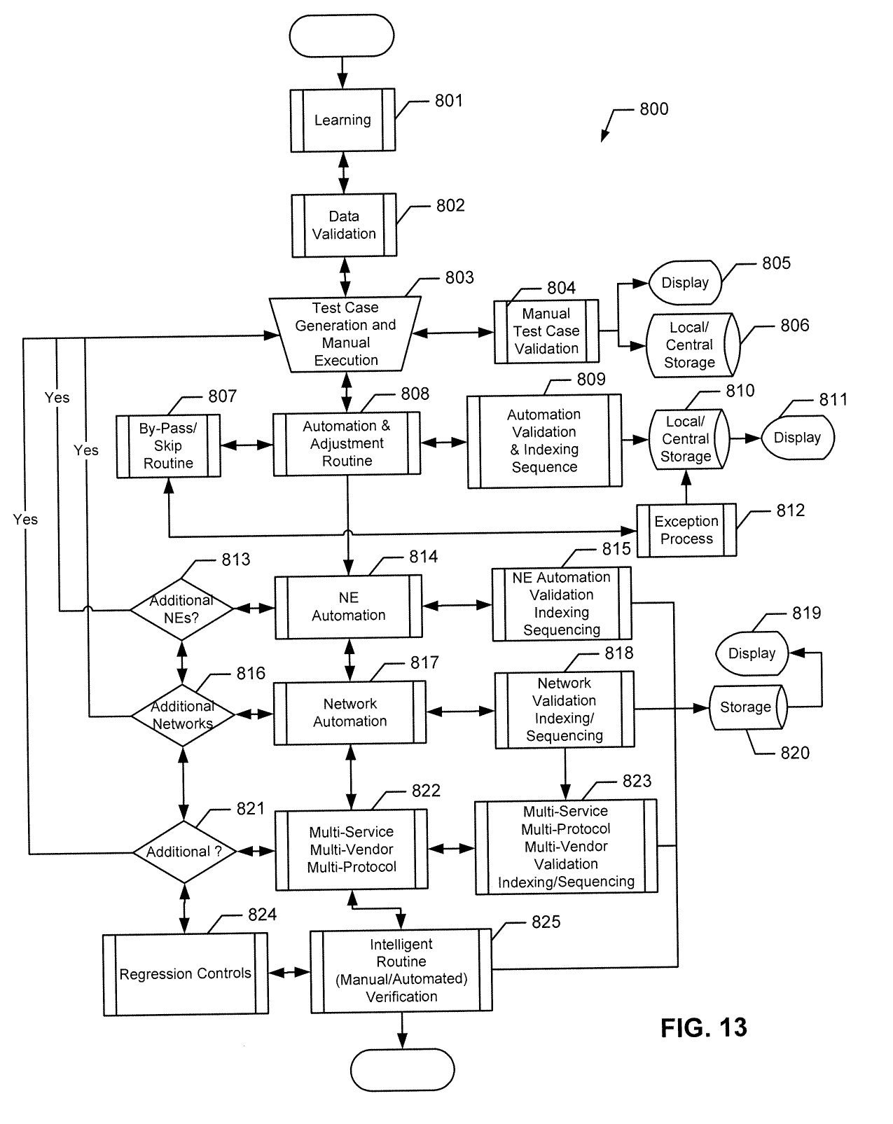

FIG. 13 depicts an alternative embodiment of a test automation process 800 for a multi-service, multi-vendor, and multi-protocol network environment. In particular, process 800 begins at learning step 801. During learning step 801, a series of initialization processes are performed, including setting network parameters, studying service requirements specified by the service provider, and creating network circuits that may include one or more networks such as the SONET ring networks depicted in FIGS. 5 and 7. In addition, parameters and features associated with the networks are enabled. At data validation step 802, the initial parameters and service requirements are propagated to every network nodes across all of the network circuits. These data are then validated.

When the network circuits and their parameters meet the requirements specified by the service provider, process 800 proceeds to step 803 to generate a test case. Alternatively, a test suite is generated to include a plurality of test cases. At step 803, the test case or cases are executed step by step on the service provider system through a manual execution process to generate manual test results. As depicted in FIG. 1, the service provider system may include, for example, an upper level layer, a mid-level layer, and a physical layer. The physical layer may further include, for example, one or more individual communications networks with multiple network elements. In addition, the service provider system may use equipment from multiple venders based on multiple protocols.

The test results generated in the manual execution process many include, for example, a screen shot image generated by a menu selection through the GUI of the EMS or NMS system. At step 804, the manual test results are validated against the service requirements specified by the service provider. These service requirements include, for example, expected results generated by a certain menu selection or a command operation. If the manual test results do not meet the service requirements, process 800 proceeds back to step 803, at which the parameters of the test case are adjusted and the test case is re-executed. The adjusted manual test results are again validated at step 804. Steps 803 and 804 are repeated until the test case is fully validated. The validated manual test results are displayed (step 805) and stored in a local or central storage (step 806).

After the test case is validated, process 800 proceeds to step 808 to automate the test case. At step 808, the test case is first executed through an automation process on the EMS or NMS system. The automated test results are then validated against the earlier stored manual test results (step 809). If the automated test results match the manual test results, the test case is deemed automatable. At step 809, the automatable test case is further indexed in a time sequence with other automatable test cases into an automation Suite. At step 810, the automatable test case and the automated test results are stored. At step 811, the automated test results are displayed.

If, on the other hand, the automated test results do not match the manual test results at step 808, the parameters of the test case are adjusted in an adjustment routine and the adjusted test case is re-executed through the automation process to generate adjusted automated test results. The adjusted automated test results are then validated against the manual test results at step 809. Steps 808 and 809 are repeated for multiple times (e.g., 10 times). If the test case repeatedly fails validation step 809, the test case is passed to a bypass/skip routine at step 807. In the bypass/skip routine, the expected test results are directly inserted into the test script of the test case to bypass or skip the test step that fails the validation. The test case with the bypassed test step is then re-executed at step 808 and re-validated at step 809. Alternatively, the test case that fails the validation is passed to an exception process at step 812. The exception process inserts an exception into the test script of the test case. When the test case is further executed during subsequent automated testing, the exception prompts a user to manually adjust the test in accordance with the service requirements. The test case with exception is also stored locally or in a central memory.

When the test case has been determined automatable or exceptions are properly handled, process 800 proceeds to step 814, at which a network element (NE) is added into the testing system. The earlier stored test case is then executed through the automation process to generate the NE automated test results. The NE automated test results are validated against the earlier stored manual test results at step 815. If the NE test results pass the validation, the test case is indexed in a time sequence with other test cases for that network element into a Network Element automation suite. The test cases and NE automated test results are stored in a storage (step 820) and displayed to the user (step 819). At step 813, if additional network elements are needed, process 800 proceeds to add the additional network elements and then back to step 803 to generate test cases for the additional network elements. The earlier steps are repeated for the newly added network elements.

If no additional network elements are needed, process 800 proceeds to step 817 to test each network in the service provider system. At step 817, the test case is executed through the automated execution process to test a particular network such as optical network 106A, switched network 106B, packet network 106C, and IP network 106D. At step 818, the network automated test results are validated against the earlier stored manual test results. If the network automated test results pass the validation, the test case is again indexed in a time sequence for that network (step 818). The test case and the test results are then stored (step 820) and displayed (819). If the network automated test results fail the validation at step 818, the parameters of the test case are adjusted, and the test case is re-executed at step 817. The adjusted network automated test results are re-validated at step 818. Steps 817 and 818 are repeated until the network automated test results pass the validation. At step 816, if additional networks are needed, process 800 proceeds to add the additional networks and then proceeds back to step 803 to generate test cases for the additional networks. The earlier steps are then repeated for the additional networks.

If no additional networks are needed, process 800 proceeds to step 822 to execute the test case through the automated execution process across the entire multi-service, multi-vendor, and multi-protocol service provider system. The automated test results are then validated against the earlier stored manual test results at step 823. If the automated test results pass the validation, the test case is indexed in a time sequence at step 823 into a Multi-Service, Multi-Protocols, Multi-Vendor automation suite. The test case and the automated test results are then stored (step 820) and displayed (829). If, on the other hand, the automated test results fail the validation at step 823, the parameters of the test case are adjusted, and the test case is re-executed at step 822. The adjusted test results are re-validated at step 823. Steps 822 and 823 are repeated until the adjusted test results pass the validation. At step 821, if additional services, vendor equipment, or protocols are needed, process 800 proceeds to add the additional services, vendor equipment, and protocols, and then proceeds back to step 803 to generate test cases for the added system components.

After the entire service provider system is tested at step 822, the earlier stored results are again examined by an intelligent routine at step 825. The intelligent routine may utilize a human operator or an artificial intelligent process to further verify the test results and to ensure the stored results conform to the service requirements. The examination results are stored (step 820) and displayed (step 819). During step 825, process 800 determines whether any changes or updates have been made in the vendor equipment. If any changes or updates are made, process 800 proceeds to step 824 to determine if regression tests are required. If regression tests are required, process 800 determines if network elements, networks, services, vendor equipment, or protocols must be added for the regression tests. If any additional system component is needed, process 800 proceeds to add the components (steps 813, 816, and 821) and then proceeds back to step 803 to create test cases for the newly added components. If no additional components are needed, process 800 then performs the regression tests by re-executing the earlier stored test cases at step 814, 817, and/or 822.

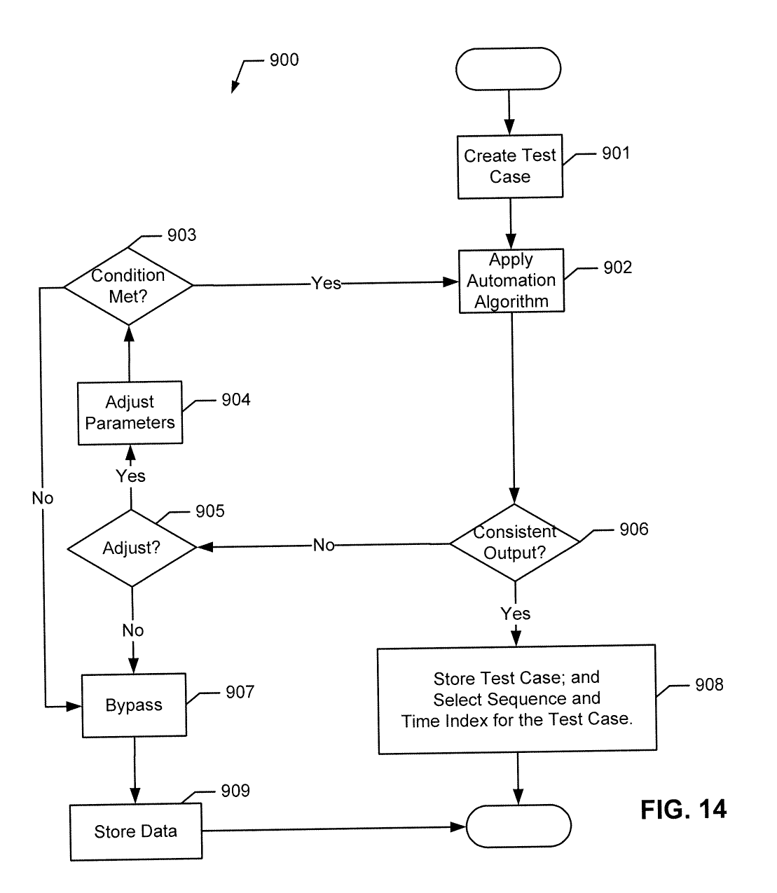

FIG. 14 depicts a process 900 for automating a test case or a suite of test cases. Process 900 can be a part of process 800 depicted in FIG. 13 or a standalone process executed through automation client 108 or automation server 110. In particular, process 900 begins at step 901, at which a test case or a suite of test cases is created. At step 902, an automation algorithm is applied to the test case or the suite. In particular, the test case or the suite is further manually executed on the service provider system. The manual test results are stored. The test case or the suite is then executed through an automated process on the service provider system. The automated test results are stored. At step 906, the automated test results are validated against the manual test results. In addition, a counter is kept at step 906 to record how many times the test case has failed the validation. If the automated test results of the test case pass the validation at step 906, the test case is stored at 908. In addition, the test case is indexed in a time sequence with other test cases.

If, at step 906, the automated test results fail the validation, process 900 proceeds to step 905 to determine whether additional efforts should be invested to make the test case automatable. For example, when the test case has previously failed the validation for multiple times (e.g., 10 times) at step 906, process 900 proceeds to a bypass step 907, at which a bypass routine is applied to the test case. In the bypass routine, the expected test results generated through the manual testing are directly inserted into the test script. The bypass data are stored on automation client 108 or automation server 110 for retrieval by subsequent automated testing. The bypass data allows the subsequent automated testing carry on without generating errors.

If it is determined at step 905 that additional adjustment is still possible to make the test case automatable, process 900 proceeds to step 904 to make additional adjustment to the parameters of the test case. In general, if the counter for a test case at step 906 has not reached a predetermined value (e.g., 10 times), additional adjustments are still possible. At step 903, the adjusted test case is further examined against the service requirements or other conditions specified by the service provider. If the conditions or requirements can be satisfied, the adjusted test case is re-executed at step 902 and re-validated at step 906. If, on the other hand, the conditions or requirements cannot be satisfied at step 903, process 900 proceeds to the bypass routine at step 907 to insert the bypass data into the test script.

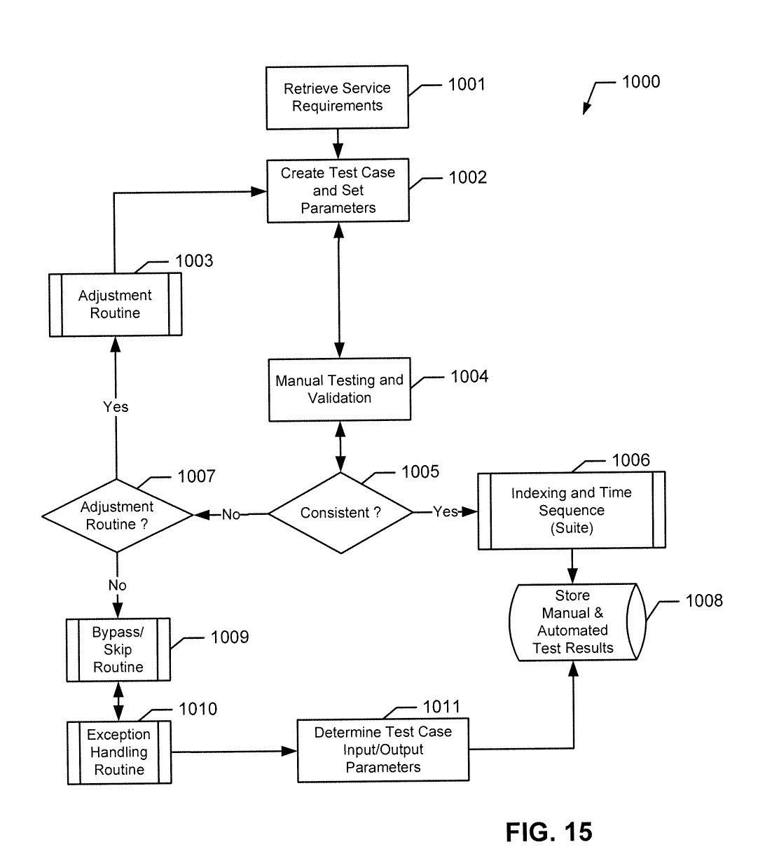

FIG. 15 depicts an adjustment-bypass process 1000. Process 1000 can be part of process 800 depicted in FIG. 13 or a standalone process executed through automation client 108 or automation server 110. Process 1000 begins at step 1001, in which the service requirements specified by the service provider is retrieved. Based on the service requirements, a test case is created and the parameters for the test case are set at step 1002. At step 1004, the test case is manually executed and the manual test results are validated against the service requirements specified by the service provider. At step 1005, the automated test results are validated against the earlier stored manual test results. If the test results are consistent, the test case is deemed automatable. The process 1000 then proceeds to step 1006 to index the test case in a time sequence or a suite. The test case, the manual test results, and the automated test results are then stored at step 1008.

At step 1005, process 1000 further associates a counter to the test case. The counter increases by one each time the test case fails the validation. When it is determined that a test case fails the validation at step 1005, process 1000 further determines whether the counter has reached a predetermined threshold value (e.g., 5, 10, 20, etc.) at step 1007. If the counter has not reached the threshold value, process 1000 proceeds to steps 1003 and 1002 to adjust the parameters of the test case based on the validation results. Adjustment routine 1003 attempts to make the test case fully automatable. The adjusted test case is then re-executed at step 1004 and re-validated at step 1005.

If, on the other hand, process 1000 determines that the counter associated with the test case reaches the threshold value, process 1000 proceeds to bypass/skip routine 1009, in which the bypass data are inserted into the automated test script of the test case. Bypass data may include, for example, the expected test results or predetermined parameters at the particular point of the script. Alternatively, the automated test script of the test case may be modified to skip the particular test steps that fail the validation. In addition, an exception handing routine is determined based on the sequence of the events in the test case and inserted into the automated test script of the test case to handle exceptions during the automated testing. At step 1011, the input/output parameters of the test case are determined for carrying out the exception handling routine. All of the bypass data, the exception handling routine, and the input/output parameters are stored in a local or central memory.

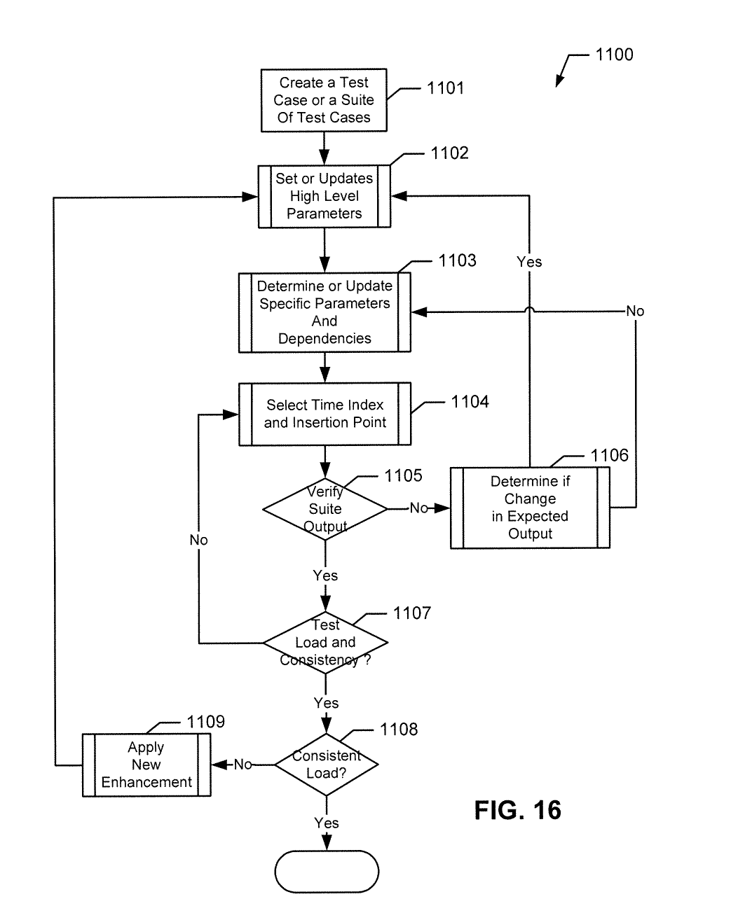

FIG. 16 depicts a learning process 1100, which may be part of process 800 depicted in FIG. 13 or a standalone process. Process 1100 begins at step 1101, at which a test case or a suite of test cases are created. At step 1102, high level parameters of the test case or cases are set based on the service requirements specified by the service provider. These high level parameters are applicable to the entire service provider system. At step 1103, specific parameters of the test case or cases are set. These specific parameters are only applicable within a limited realm of system components, services, or protocols. Additionally, when a suite of test cases is created, the dependencies of the test cases are determined at step 1103. The dependencies of the test cases specify the temporal or logical relationships of the test cases within the suite. At step 1104, a time index within a time sequence is selected for each test case and an insertion point was determined for the test case in the time sequence. At step 1105, a suite output is verified against the service requirements. If the suite output fails the verification, process 1100 proceeds to step 1106 to determine if the expected output should be changed. If the expected output should not be changed, process 1100 proceeds to step 1103 to update the specific parameters of the test case, and re-execute steps 1103, 1104, and 1105. If, on the other hand, the expected output should be changed, process 1100 proceeds to step 1102 to update the high level parameters of the test case and re-execute steps 1102-1105.

If, at step 1105, the suite output is verified, process 1100 proceeds to step 1107 to test load and consistency. Load is a system parameter referring to the number of test cases that can be executed by the tested system component within a predetermined time period (e.g., one second or five seconds). Each system component in the service provider system has an associated load requirement. If the load and consistency is not to be tested, process 1100 proceeds back to step 1104. If, on the other hand, the load and consistency test is to be executed and the load is consistent (step 1108), process 1100 terminates. if it is determined that the load is not consistent at step (1108), new enhancements are applied to the tested component. New enhancements may include, for example, adding additional memory or updating the hardware of the components. After the system component is enhanced, process 1100 proceeds back to step 1102 and repeats the earlier steps.

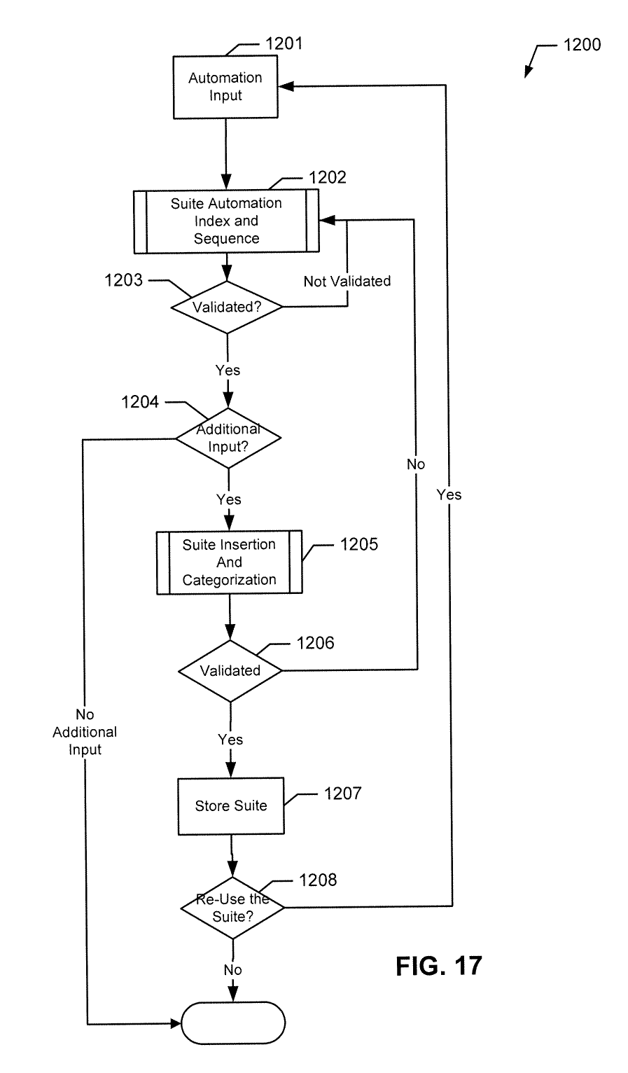

FIG. 17 depicts a sequence indexing process 1200, which may be part of process 800 depicted in FIG. 13 or may be a standalone process. As described above, the testing system is created piece by piece. After a test suite is completed, the test cases within the suite are indexed in a time sequence. The time sequence specifies a temporal relationship among all of the test cases within the suite.

Process 1200 begins at step 1201 to receive a test case as an automation input. The test case is then indexed and inserted into a time sequence at step 1202. At step 1203, it is determined if the time index and the time sequence are validated. If they are not validated, process 1200 proceeds back to step 1202 to adjust the time index and the time sequence. If the time index and the time sequence are validated, process 1200 proceeds to step 1204 to determine if there is additional input. If there is no additional input, process 1200 terminates. if additional input is presented, process 1200 proceeds to step 1205 to receive the additional input, insert the additional input into the test suite, and categorize the additional input. The additional input may specify, for example, new hardware cards, new system components, new system features, or new services provided to the communication system. At step 1206, the suite with the additional input is again validated. If the validation fails, process 1200 proceeds back to step 1202 to adjust the time index and the time sequence. If the test suite with additional input is validated, it is stored at step 1207. At step 1208, it is determined whether the suite is to be re-used. Certain test suites may be re-used. The parameters of a hardware component within a network element, such as a network port or a network address, can usually be re-used in other test cases or suites. If a test or suite is to be re-used, process 1200 proceeds back to step 1201 to receive new automation input. If the suite is not to be re-used, process 1200 terminates.

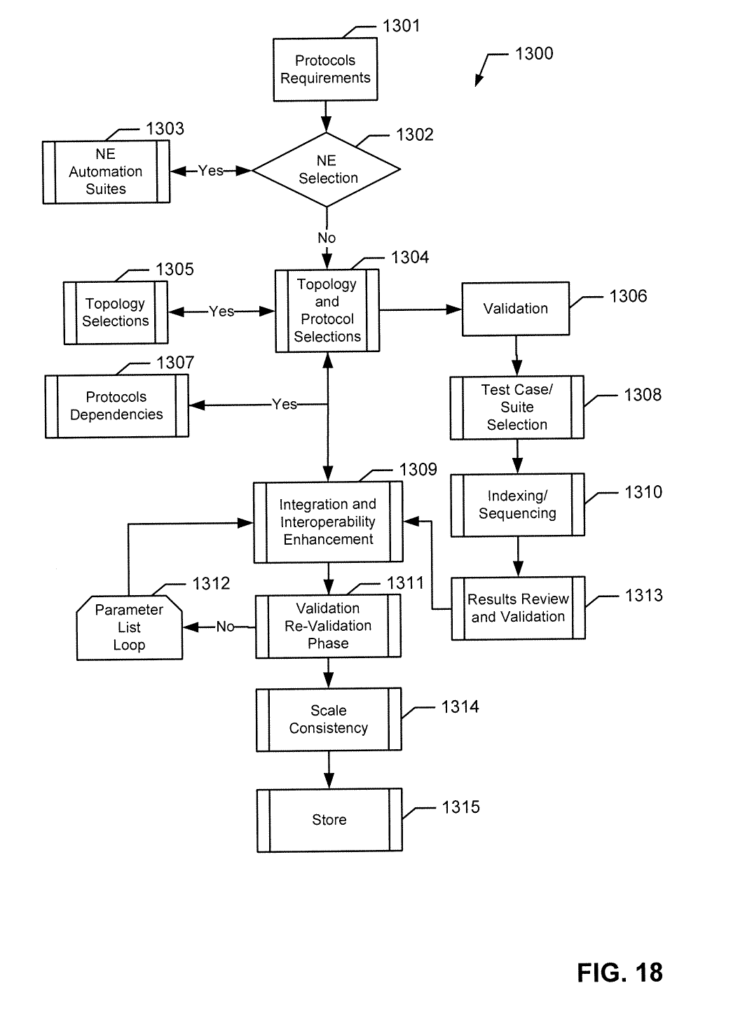

FIG. 18 depicts a network topology process 1300 for creating a network topology in a multi-service, multi-vendor, and multi-protocol environment. Process 1300 begins at step 1301, at which the protocol requirements of the network are specified by the service provider. At step 1302, if a network element selection is to be performed, process 1300 proceeds to step 1303 to select one or more network element automation suites. Here, the network elements associated with the automation suites may be provided by multiple vendors. After determining that no additional network element selection is needed, process 1300 proceeds to step 1304 to determine if topology and protocol selections are needed. If the topology selection is needed, process 1300 proceeds to step 1305 to select one or more topologies. The available topologies include, for example, SONET ring network, switched network, packet network, IP network, or other wired or wireless network topologies. If the protocol selection is needed, process 1300 proceeds to step 1307 to select one or more protocols for the network. Available network protocols include, for example, those listed in FIG. 6.

At step 1304, it is further determined if the validation is needed. If validation is needed, process 1300 proceeds to step 1306 to begin validating the selected network elements, topologies, and protocols against the requirements specified by the service provider. Specifically, a test case or a test suite is selected (step 1308) and indexed (1310). The test case or test suite is executed and the results are validated at step 1313. If it is determined that validation is not needed at step 1304 or validation is completed at step 1313, process 1300 proceeds to step 1309 to integrate the selected network elements, topologies, and protocols into the service provider system. Here, the interoperability of the system components and parameters is further enhanced. At step 1311, the integrated system is then validated against the requirements specified by the service provider. If the integrated system fails the validation, process 1300 proceeds to parameters list loop 1312 to adjust/modify the parameters of the system to improve the validation. Accordingly, steps 1309, 1311, and 1312 are repeated until the system passes the validation. At step 13114, the scale of the system is tested to maintain scale consistency. At step 1314, the selected system parameters and the validation results are stored.

It is further noted that the network elements available for selection in step 1303 are provided by multiple vendors. In general, the selected network elements and the EMS or NMS system managing the network elements may be provided by the same vendor. Alternatively, the selected network elements may not have the associated vendor-provided EMS or NMS system. When these network elements are added into the service provider system, they are not readily testable by the testing function provided in other vendor's EMS or NMS system. In order to make these network elements testable, the testing system described herein utilizes a third-party testing tool, such as EGGPLANT, to customize the testing script, so that the network elements provided by different vendors can be tested under a single framework.

In the preceding specification, specific exemplary embodiments have been described with reference to specific implementations thereof. It will, however, be evident that various modifications and changes may be made thereunto, and additional embodiments may be implemented, without departing from the broader spirit and scope of the invention as set forth in the claims that follow. The specification and drawings are accordingly to be regarded in an illustrative rather than restrictive sense.

What is claimed is:

1. A method for automating tests in a communications network, comprising:
creating a test case;
generating expected testing results by manually executing the test case on a computer system through the client computer;
automating the test case on a client computer;
performing automated testing on the computer system using the test case to generate automated testing results;
validating, by a computer system, the test case by comparing the automated testing results with the expected testing results;
marking the test case as automatable if the automated testing results match the expected testing results; and
storing, by the computer system, the automatable testing case for later executions.

2. The method of claim 1, wherein generating the expected testing results comprises:
manually operating the program through a plurality of testing steps; and
storing the expected testing results corresponding to each testing step.

3. The method of claim 2, wherein the generating expected testing results comprises collecting screen shot images at the testing steps.

4. The method of claim 2, wherein validating the test case comprises comparing the expected testing results and the automated testing results for each step.

5. The method of claim 1, further comprising:
adjusting a parameter of the test case if validation of the test case fails;
re-executing the test case with the adjusted parameter to generated adjusted automated testing results; and
re-validating the test case by comparing the expected testing results with the adjusted automated testing results.

6. The method of claim 1, further comprising:
obtaining a plurality of automatable test cases;
determining a sequence for the automatable test cases;
grouping the automatable test cases into a test suite; and
ordering the automatable test cases into a time-indexed sequence based on event times of the automatable test cases.

7. The method of claim 5, comprising repeating the steps of claim 5 for a predetermined number of times.

8. The method of claim 1, wherein:
the computer system is disposed in one of an element management system or a network management system of a telecommunication network; and
the computer system is configured to manage a plurality of network elements of the telecommunication network.

9. The method of claim 8, wherein the network elements form at least one of an optical network, a packet network, a switched network, or an IP network.

10. The method of claim 8, wherein the telecommunication network is configured based on telecommunication management network (TMN) architecture.

11. A system for providing automated testing including:
an automation client for receiving user input to:
create a test case;
allow a user manually execute the test case on a computer system to generate expected testing results; and
execute automated testing on the computer system using the test case to generate automated testing results; and
an automation server for:
storing the expected testing results and the automated testing results;
validating the test case by comparing the expected testing results with the automated testing results; and
storing the test case when the expected testing results match the automated testing results.

12. The system of claim 11, wherein the automation server marks the test case as automatable when the expected testing results match the automated testing results.

13. The system of claim 11, wherein:
the client receives user input to manually execute the test case on the computer system through a plurality of testing steps; and
the automation server stores the expected testing results corresponding to the testing steps.

14. The system of claim 11, wherein the expected testing results include screen shot images collected at the testing steps, the screen shot images being generated by the computer system according to manual execution of the test case.

15. The system of claim 11, wherein:
the client:
adjusts a parameter of the test case if validation of the test case fails; and
re-executes the test case with the adjusted parameter on the computer system to generate adjusted automated testing results; and
the automation server re-validates the test case by comparing the expected testing results with the adjusted automated testing results.

16. The system of claim 11, wherein:
the computer system is disposed in one of a network management system or an element management system of a telecommunication network; and
the computer system is configured to manage a plurality of network elements of the telecommunication network.

17. A tangibly embodied computer-readable storage medium storing instructions which, when executed by a computer, cause the computer to perform a method comprising:
creating a test case on a client computer;
generating expected testing results by allowing a user manually to execute the test case on a computer system through the client computer;
performing automated testing on the computer system using the test case to generate automated testing results;
validating the test case by comparing the automated testing results with the expected testing results;
marking the test case as automatable if the automated testing results match the expected testing results; and
storing the automatable testing case for later executions.

18. The computer-readable medium of claim 17, wherein the method further comprises:
adjusting a parameter of the test case if validation of the test case fails;
re-executing the test case with the adjusted parameter to generated adjusted automated testing results; and
re-validating the test case by comparing the expected testing results with the adjusted automated testing results.

19. The computer-readable medium of claim 17, wherein the method further comprising:
obtaining a plurality of automatable test cases;
determining sequence and index times for the automatable test cases;
grouping the automatable test cases into a test suite; and
ordering the automatable test cases into a time-indexed sequence based on the sequence and index times.

20. The computer-readable medium of claim 17, wherein:
the computer system is disposed in one of an element management system or a network management system of a telecommunication network; and
the computer system is configured to manage a plurality of network elements of the telecommunication network.
